(19) United States
(12) Patent Application Publication
(10) Pub. No.: US 2008/0038672 A1
(43) Pub. Date: Feb. 14, 2008

(54) METHOD FOR MANUFACTURING ELECTRONIC DEVICE, ELECTRONIC DEVICE, AND ELECTRONIC APPARATUS

(75) Inventors: Shinobu YOKOKAWA, Fujimi-machi (JP); Hiroshi TAKIGUCHI, Suwa-shi (JP); Hitoshi YAMAMOTO, Chino-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 11/829,434

(22) Filed: Jul. 27, 2007

(30) Foreign Application Priority Data
Aug. 3, 2006 (JP) 2006-212619
Jun. 25, 2007 (JP) 2007-166906

(51) Int. Cl. G03C 5/00

(52) U.S. Cl. 430/311

(57) ABSTRACT

A method for manufacturing an electronic device including a substrate and an organic thin film patterned in a predetermined shape includes: a) forming a coating film made of a first compound on a surface of the substrate, the first compound including a polymerization initiation site bindable with a second compound and inducing a cross-linking reaction responding to light; b) forming a first layer by site-selective irradiation of light on a region corresponding to the organic thin film of the coating film so as to pattern the coating film in the predetermined shape; and c) forming the organic thin film including the first layer and a second layer, the second layer being formed on the first layer by contacting a liquid including the second compound with the first layer so as to bind the polymerization initiation site and the second compound.

### BACKGROUND

1. Technical Field

Several aspects the present invention relate to a method for manufacturing an electronic device, the electronic device, and an electronic apparatus.

2. Related Art

For example, an electronic device such as an organic thin film transistor and a biosensor has an organic thin film such as an insulating film patterned in a predetermined shape on a substrate. Such an organic thin film is commonly formed by applying a liquid material made of a polymeric material dissolved in a solvent on a substrate with a supply method such as a spin casting method or a spraying method. However, the organic thin film obtained in such a method has a problem in which sufficient characteristics (mechanical characteristics, chemical characteristics, and electrical characteristics) are not provided because of low molecular density of the film.

On the other hand, in recent years, a forming method by graft polymerization has been developed instead of such a method for forming an organic thin film (e.g. refer to JP-A-10-17688 and JP-A-11-43614). This method is a method to bind a polymer chain to a side chain so as to be hung thereto. A film (polymer) obtained by this method is also called as a polymer brush. This polymer brush can have a polymer chain at high density by increasing density at a portion to which a polymer chain of a side chain may bind (polymerization initiation site), providing an organic thin film having high molecular density.

Specifically, such a polymer brush is provided with a polymerization initiation layer that is a starting point of graft polymerization on a substrate and formed by binding a polymer chain to this polymerization initiation layer.

In order to employ the polymer brush to an organic thin film for variety of electronic devices, as described above, the organic thin film needs to be patterned in a predetermined shape. However, in methods according to JP-A-10-17688 and JP-A-11-43614, a liquid film is formed by providing a material composing a polymerization initiation layer on a whole surface of a substrate by the spin casting method or the spraying method mentioned above. Then, this liquid film is heated so as to form the polymerization initiation layer. With such a method, the whole surface or a wide area of the substrate is heated since it is extremely hard to heat the substrate partially, forming an organic thin film in a large area only. That is, with such a method, an organic thin film finely patterned cannot be obtained. Therefore, the organic thin film obtained needs to be patterned with a method such as etching, causing complication in manufacturing steps, and high cost.

Further, a method to provide a liquid material in a predetermined position on a substrate such as an ink-jet method can provide a polymerization initiator in the predetermined position. However, a providing speed is not sufficient, thereby significantly decreasing efficiency of forming organic thin films. In addition, low accuracy of a providing position of the liquid material causes difficulty in forming an organic thin film with a fine pattern.

### SUMMARY

The advantage of the invention is to provide a method that can effectively manufacture a highly reliable electronic device including an organic thin film with high density, being patterned in a predetermined shape with high accuracy of dimension, the electronic device manufactured by the method, and an electronic apparatus provided with the electronic device.

The advantage is achieved by the following aspects of the invention.

A method for manufacturing an electronic device according to a first aspect of the invention, including a substrate and an organic thin film patterned in a predetermined shape comprises: a) forming a coating film made of a first compound on a surface of the substrate, the first compound including a polymerization initiation site bindable with a second compound and inducing a cross-linking reaction responding to light; b) forming a first layer by site-selective irradiation of light on a region corresponding to the organic thin film of the coating film so as to pattern the coating film in the predetermined shape; and c) forming the organic thin film including the first layer and a second layer, the second layer being formed on the first layer by contacting a liquid including the second compound with the first layer so as to bind the polymerization initiation site and the second compound.

Accordingly, a high performance electronic device including an organic thin film with high density, being patterned in a predetermined shape at high accuracy of dimension, is effectively manufactured.

In this case, the first compound preferably includes a photocurable compound to be solidified by light irradiation as a major constituent.

Accordingly, a light irradiation region is arranged, thereby the coating film is easily patterned in a small amount of time so as to provide the first layer.

In this case, the photocurable compound preferably includes at least one of a prepolymer material and a polymer material, the prepolymer material and the polymer material having a first repeated structure unit including the polymerization initiation site and a second repeated structure unit inducing a cross-linking reaction by light irradiation.

Accordingly, strength of the first layer is enhanced due to the cross-linking reaction. Further, density of a cross-linking structure formed by the cross-linking reaction of the photocurable compound and density of the polymerization initiation site included in the photocurable compound are adjustable by setting a ratio of each repeated structure unit. As a result, hardness (flexibility) and density of the first layer obtained are adjustable.

In this case, the first repeated structure unit preferably includes a structure shown in a formula 1 below.

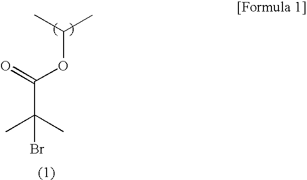

Occurrence of living polymerization is thus ensured, resulting in effective binding of the polymerization initiation site and the second compound.

In this case, the second repeated structure unit preferably includes a structure shown in a formula 2 below.

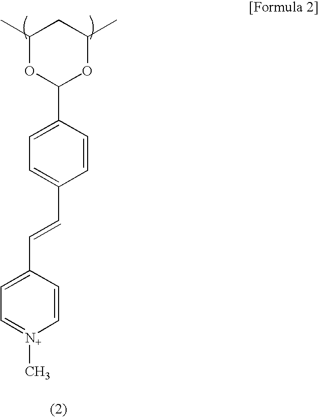

This can establish a more solid molecular network and provide the first layer having more strength.

In this case, a ratio of the first repeated structure unit in the photocurable compound is preferably from 0.5 mmol % to 49.5 mol % inclusive.

The second compound is thus bound to the polymerization initiation site at high density. That is, while the number of polymerization initiation sites that is sufficient for the second compound to bind to at high density is ensured, molecules of the second compound are prevented from interfering each other because of the excessive number of polymerization initiation sites.

In this case, a ratio of the second repeated structure unit in the photocurable compound is preferably from 0.5 mol % to 10 mol % inclusive.

Accordingly, a molecular network by the second repeated structure unit is further ensured to be formed. That is, it is ensured that a case where a sufficient size of the molecular network is not formed due to lack of the second repeated structure unit, or a case where the molecular network is inhibited to form by the molecules of the second repeated structure unit interfering each other due to excessive second repeated structure units is prevented. The first layer is thus solidified reliably.

In this case, it is preferable that the photocurable compound further include a third repeated structure unit having a hydrophilic site.

This can sufficiently enhance hydrophilicity of the photocurable compound. As a result, the photocurable compound is ensured to dissolve in a water-soluble solvent, thereby the liquid material obtained as above becomes easy to handle.

In this case, step a) includes contacting a polymerization initiator with the first compound, the polymerization initiator preferably inducing the cross-linking reaction and generating radical by light irradiation.

Accordingly, when a double bond is included in the second repeated structure unit, action of the photo-polymerization initiator generating radical can induce a radical polymerization particularly effectively.

A method for manufacturing an electronic device according to a second aspect of the invention including a substrate and an organic thin film patterned in a predetermined shape comprises: d) forming a coating film made of a first compound on a surface of the substrate, the first compound including a polymerization initiation site bindable with a second compound and inducing a decomposition reaction responding to light; e) forming a first layer by site-selective irradiation of light on a region other than a region corresponding to the organic thin film of the coating film so as to pattern the coating film in the predetermined shape; and f) forming the organic thin film including the first layer and a second layer, the second layer being formed on the first layer by contacting a liquid including the second compound with the first layer so as to bind the polymerization initiation site and the second compound.

Accordingly, a high performance electronic device including an organic thin film with high density, being patterned in a predetermined shape at high accuracy of dimension, is effectively manufactured.

In this case, the first compound includes a photodegradable compound to be decomposed by light irradiation as a major constituent.

Accordingly, a light irradiation region is arranged, thereby the coating film is easily patterned in a small amount of time so as to provide the first layer.

In the method according the first aspect of the invention, the polymerization initiation site is preferably a functional group including halogen.

For example, a double bond in the second compound is cleaved by an action of the polymerization initiation site, causing a continuous reaction to bond a connector generated by being cleaved to the polymerization initiation site. That is, excitation of such living polymerization is ensured.

In this case, the second compound preferably includes at one of a (meth) acrylic acid ester-based compound, an epoxy-based compound, and an oxetane-based compound as a major constituent.

These compounds are particularly easy to bind with the polymerization initiation site. Therefore, the polymerization initiation site and the second compound are bound to each other in a shorter time, thereby simplifying a step to form the second layer.

In this case, a wavelength of light to be irradiated in step b) is preferably from 200 nm to 500 nm inclusive.

When the wavelength of the light as above is used, relatively high light energy is provided to the second repeated structure unit while damage on the polymerization initiation site included in the first repeated structure unit is prevented with certainty. Accordingly, the structure change of the coating film caused by the light irradiation is effectively performed.

In this case, step c) preferably includes binding the polymerization initiation site to the second compound by living polymerization.

Accordingly, when a number of the second compounds are bound to the polymerization initiation site, a polymerization initiation site is regenerated at an end of the second compounds bound, causing a continuous reaction in which polymerization reaction occurs every time when the second compound is newly provided. Therefore, by changing a quantity of the second compound (monomer) to be provided to a reaction system, a degree of polymerization of the polymer to be synthesized becomes precisely controllable. As a result, thickness and density of the second layer and the organic thin film are adjustable adequately and precisely.

In the method according to the first aspect of the invention, step c) preferably includes contacting the liquid with the first layer while at least one of light and heat is applied on the first layer.

Activation of the polymerization initiation site is thus enhanced, resulting in more effective binding of the polymerization initiation site and the second compound. Consequently, as described above, when the first layer includes the polymerization initiation site at a high rate, a number of the second compounds can be bound to the polymerization initiation site. Therefore, density of the second layer is increased, effectively providing the organic thin film that is superior in electrical characteristics, mechanical characteristics, and chemical characteristics.

An electronic device according to a third aspect of the invention is manufactured by the method for manufacturing an electronic device according to the first aspect of the invention.

Accordingly, a highly reliable electronic device including an organic thin film with high density, being patterned in a predetermined shape at high accuracy of dimension, is effectively obtained.

The electronic device may be a thin film transistor or a biosensor.

This makes it possible to provide a highly reliable thin film transistor or biosensor.

An electronic apparatus according to a fourth aspect of the invention includes the electronic device according to the third aspect of the invention.

The electronic apparatus with high reliability can be thus provided.

### BRIEF DESCRIPTION OF THE DRAWINGS

The invention will be described with reference to the accompanying drawings, wherein like numbers reference like elements.

FIG. 1 is a plan view showing an active matrix device including an electronic device according to a first embodiment of the invention.

FIG. 2 is a cross sectional view cut along the line X-X shown in FIG. 1.

FIGS. 3A through 3D are diagrams (longitudinal sectional views) explaining a method for manufacturing the active matrix device shown in FIGS. 1 and 2.

FIGS. 4E through 4H are diagrams (longitudinal sectional views) explaining the method for manufacturing the active matrix device shown in FIGS. 1 and 2.

FIGS. 5I and 5J are diagrams (longitudinal sectional views) explaining a method for manufacturing the active matrix device shown in FIGS. 1 and 2.

FIG. 6 is a schematic view (perspective view) showing a state in which a biosensor including an electronic device according to a second embodiment of the invention is attached to measuring equipment.

FIG. 7 is a plan view schematically showing the biosensor shown in FIG. 6.

FIG. 8 is a sectional view of the biosensor shown in FIG. 7 cut along the line A-A.

FIG. 9 is a partially enlarged view cut along the line A-A shown in FIG. 8.

FIGS. 10A through 10F are diagrams (longitudinal sectional views) explaining a method for manufacturing the biosensor shown in FIG. 8.

FIG. 11 is a perspective view showing an electronic paper provided with the electronic apparatus according to the invention.

FIG. 12 is a longitudinal sectional view showing an electrophoretic display provided with an active matrix device.

FIGS. 13A and 13B are diagrams showing a display provided with the electronic apparatus according to the invention. FIG. 13A is a sectional view, while FIG. 13B is a plan view.

### DESCRIPTION OF EXEMPLARY EMBODIMENTS

A method for manufacturing an electronic device, the electronic device, and an electronic apparatus will now be described in detail based on preferred embodiments with reference to the accompanying drawings.

### First Embodiment of an Electronic Device

First, an active matrix device (thin-film transistor circuit) including an electronic device according to a first embodiment of the invention will be explained.

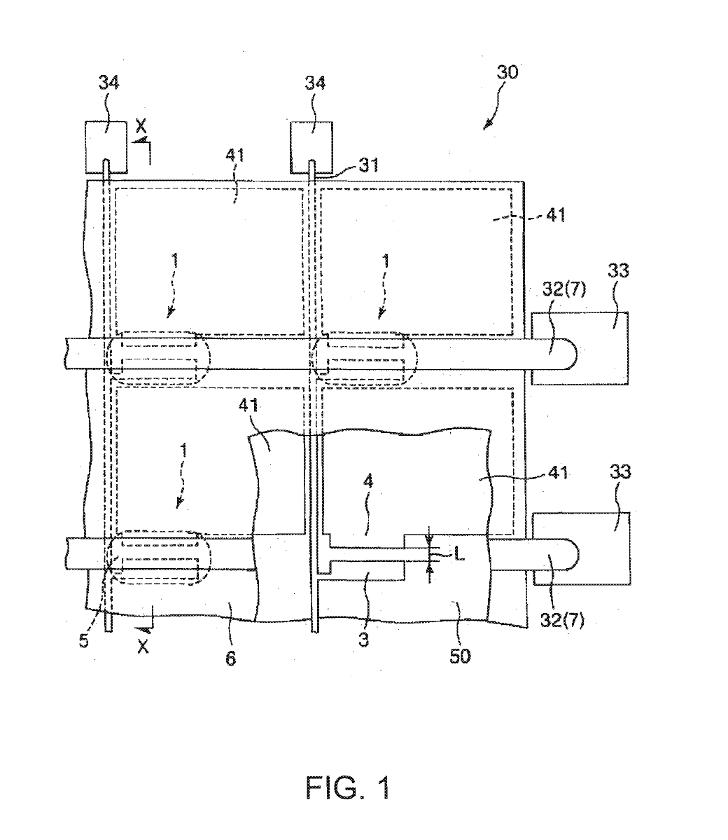

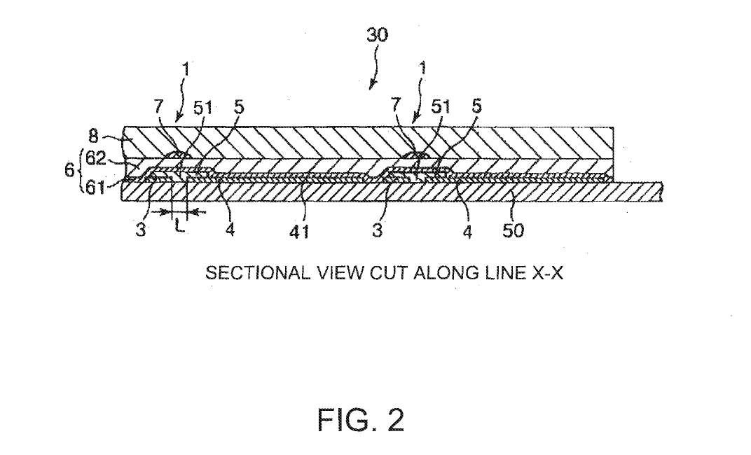

FIG. 1 is a plan view showing the active matrix device including the electronic device according to the first embodiment of the invention, while FIG. 2 is a sectional view cut along the line X-X shown in FIG. 1. In the following description, the top side in FIG. 2 is described as “up”, while the bottom side is described as “down”.

An active matrix device 30 shown in FIG. 1 includes a plurality of data lines 31, a plurality of scanning lines 32 perpendicular to the plurality of data lines, and a thin film transistor 1 provided adjacent to each of intersections of the data lines 31 and the scanning lines 32.

Each transistor 1 is provided with a source electrode 3, a drain electrode 4, an organic semiconductor layer 5, a gate insulating layer 6, and a gate electrode 7.

In this embodiment, the thin-film transistor 1 arranged in a line towards in lateral directions (to right and left) in FIG. 1 is formed so as to be integrated with the gate electrode 7 thereof, composing the scanning line 32. Then, one end of the scanning line 32 is coupled to a connection electrode 33 formed on a substrate 50. The connection electrode 33 is a connection terminal to be coupled to an external electrode.

Further, the source electrode 3 included in each of the transistors 1 is coupled to the data line 31, and the drain electrode 4 is coupled to a pixel electrode (individual electrode) 41 included in an electrophoretic display part 40 to be described later.

Each of the pixel electrodes 41 is arranged in a matrix form so as to correspond to each of the thin film transistors 1.

Now, a structure of the thin film transistors 1 will be described below.

The thin film transistor 1 includes the source electrode 3 and the drain electrode 4 separately formed on the substrate 50. The organic semiconductor layer 5 is formed so as to attach to the source electrode 3 and the drain electrode 4, and the gate insulating layer 6 is formed to attach to the organic semiconductor layer 5. Further, on the gate insulating layer 6, the gate electrode 7 is provided so as to overlap at least a region between the source electrode 3 and the drain electrode 4. In addition, a protective film 8 is formed so as to cover almost all surface of the gate insulating layer 6.

The thin film transistor 1 as above has a structure in which the source electrode 3 and drain electrode 4 are provided closer to the substrate 50 than the gate electrode 7, with the gate insulating layer 6 being between the electrodes 3 and 4, and the gate electrode 7. That is, the thin film transistor 1 has a top gate structure.

The substrate 50 supports each layer (each element) making up the thin-film transistor 1. Examples of the material of the substrate 50 include a glass substrate; a plastic substrate (resin substrate) containing polyimide, polyethylene terephthalate (PET), polyethylene naphthalate (PEN), polyethersulphone (PES), aromatic polyester (liquid crystal polymer), or the like; a quartz substrate; a silicon substrate; and a gallium arsenide substrate. In order to provide flexibility to the thin-film transistor 1, a resin substrate can be selected as the substrate 50.

A lower layer may be provided on the substrate 50. The lower layer will be formed, for example, in order to prevent diffusion of ions from the surface of the substrate 50, to improve adhesiveness (bonding characteristic) between the source and drain electrodes 3 and 4 and the substrate 50.

The lower layer may be made of silicon dioxide (SiO₂), silicon nitride (SiN), polyimide, polyamide, a polymer that is insolubilized by cross-linking, or the like, for example.

The source electrode 3 and drain electrode 4 are provided on the substrate 50 arranged to be separated from each other to keep a predetermined distance along the channel length L direction.

Examples of constituent materials of the source electrode 3 and the drain electrode 4 include metal materials such as Pd, Pt, Au, W, Ta, Mo, Al, Cr, Ti, Cu, or their alloy, and are selected from among them depending on a carrier traveling in a channel region.

For example, in a case of a P-channel thin film transistor in which a hole travels in a channel region, Pd, Pt, Au, Ni, Cu, or an alloy including these metal materials is preferably used since their work function is relatively high.

Further, as constituent materials of the source and drain electrodes 3 and 4 other than the metal materials above, one or a combination of two or more of the following substances can be used: conductive oxides such as ITO, FTO, ATO and SnO₂; carbon materials such as carbon black, carbon nanotube and fullerene; and conductive polymer materials such as polyacetylene, polypyrrole, polythiophene like poly-ethylenedioxythiophene (PEDOT), polyaniline, poly(p-phenylene), poly (p-phenylenevinylene), polyfluorene, a polycarbazole, polysilane, and derivatives of these substances.

The conductive polymer material is typically used in a state in which electrical conductivity is provided after being doped with a polymer such as iron chloride, iodine, inorganic acid, organic acid, or polystyrenesulfonic acid.

Average thickness of the source and drain electrodes 3 and 4 is preferably, but not limited to, from about 30 to 300 nm, and is more preferably from about 50 to 150 nm.

The distance (distance to be separated) between the source and drain electrodes 3 and 4, namely, the channel length L is preferably in a range of from about 2 to about 30 μm, and further preferably in a range of from about 5 to about 20 μm. If the channel length L is smaller than the lower limit described above, there may be a margin of error in the channel lengths of the obtained thin film transistors 1, which may cause fluctuations in the characteristics (transistor characteristics). In contrast, if the channel length L is greater than the upper limit described above, the absolute value of the threshold voltage becomes large while the amount of the drain current becomes small, which may cause an insufficient characteristic of the thin film transistor 1.

Further, on the substrate 50, the organic semiconductor layer 5 is provided between the source electrode 3 and the drain electrode 4 so as to cover a part of the source electrode 3 and the drain electrode 4.

The organic semiconductor layer 5 is composed mainly of an organic semiconductor material (organic material exhibiting semiconducting electrical conductivity).

The organic semiconductor layer 5 is preferably oriented so as to be in nearly parallel with the channel length L direction at least in a channel region 51. This enhances carrier mobility in the channel region 51, resulting in improving an operation speed of the thin film transistor 1.

Examples of the organic semiconductor material include low molecular weight organic semiconductor materials such as a naphthalene, anthracene, tetracene, pentacene, hexacene, phtalocyanine, perylene, hydrazone, triphenylmethane, diphenylmethane, stilbene, aryl vinyl, pyrazoline, triphenylamine, triarylamine, oligothiophene, and derivative of these materials; and polymer organic semiconductor materials (conjugated polymer materials) such as a poly-N-vinylcarbazole, polyvinylpyrene, polyvinylanthracene, polythiophene, polyalkylthiophene, polyhexylthiophene, poly(p-phenylenevinylene), polythienylenevinylene, polyarylamine, pyrene formaldehyde resin, ethylcarbazole formaldehyde resin, fluorene-bithiophene copolymer, fluorene-arylamine copolymer, and derivatives of these materials. One or a combination of two or more of the above materials can be used. Particularly, it is preferable to use a material made up mainly of a polymer organic semiconductor material (conjugated polymer material). The conjugated polymer material has particularly high mobility of carriers because of the particular distribution of electron clouds therein.

The polymeric organic semiconductor materials can be formed as films by a simple process, and easily oriented. Further, among these materials, it is particularly preferable to use materials made mainly of at least one of fluorene-bithiophene copolymer, fluorene-arylamine copolymer, and derivatives of these materials as polymeric organic semiconductor materials (conjugated polymeric materials) because of their high oxidation resistance and stability in the air.

Further, the organic semiconductor layer 5 including a polymeric organic semiconductor material as a main material can be formed to be low profile and light in weight, and superior in flexibility. Therefore, it is suitable to use for a thin film transistor as a switching element of a flexible display or the like.

Average thickness of the organic semiconductor layer 5 is preferably from about 1 nm to about 200 nm, and more preferably from about 10 nm to about 100 nm.

The organic semiconductor layer 5 is not limited to a structure formed to cover the source and drain electrodes 3 and 4. It is at least required to be formed on the region between the source and drain electrodes 3 and 4 (the channel region 51).

The gate insulating layer 6 is provided on the organic semiconductor layer 5. In the embodiment, the gate insulating layer 6 is formed to cover the source and drain electrodes 3 and 4, and the organic semiconductor layer 5.

The gate insulating layer 6 insulates the gate electrode 7 from the source and drain electrodes 3 and 4.

In the embodiment, the gate insulating layer (organic thin film) 6 is formed as a stacked body of a first layer 61 and a second layer 62. The first layer is formed by patterning a coating film 60 in a predetermined shape to be described later, while the second layer is formed on the first layer 61 by graft polymerization.

Among them, the coating film 60 described later is made of a first compound, while the first layer 61 is made of a substance produced from the first compound reacted with light and structurally changed.

The first compound includes a polymerization initiation site that is bindable with a second compound composing the second layer 62 and structurally changes by reacting with light. Details on this structural change will be described later.

Further, since the first compound includes the polymerization initiation site described above, for example, when the first compound includes the polymerization initiation site at a high rate, a number of the second compounds can be bound to the first compound through the polymerization initiation site. As a result, density of the second layer 62 is increased easily, effectively providing the gate insulating layer 6 that is superior in electrical characteristics, mechanical characteristics, and chemical characteristics.

Here, the polymerization initiation site is a site that is bindable with the second compound. For example, a functional group such as a hydroxyl group, a carboxyl group, a halogen group, an amino group, an aldehyde group, a nitro group, a sulfone group, a carbonyl group, or the like can be cited.

The first compound as above preferably includes a photocurable compound causing a cross-linking reaction in a region where light is applied, or a photodegradable compound causing a decomposition reaction in a region where light is applied as a major constituent. By using these compounds as the first compound and arranging an irradiated region of light, the coating film 60 is patterned with ease in a short time, providing the first layer 61.

The first layer 61 as above may be composed of a compound having a structure shown in a formula 3 below, for example.

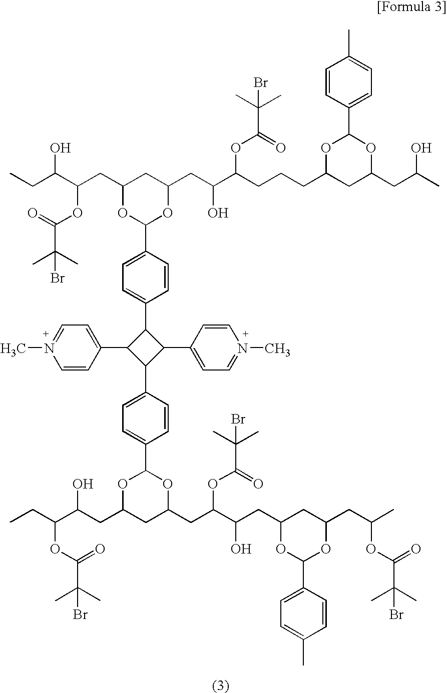

The compound includes a bromine group as the polymerization initiation site.

Further, the compound includes a structure in which a side chain includes a benzene ring, being cross-linked by an alkyl chain. Accordingly, a network of a molecular structure is formed, providing the first layer 61 that is robust.

On the other hand, the second layer 62 is made of the second compound.

The second compound is bound (by graft polymerization) to the polymerization initiation site included in the first compound of the first layer 61 formed on the substrate 50. Then, a plurality of the second compounds are linked in a chain state, thereby the second layer 62 in a desired thickness is obtained. Accordingly, the gate insulating layer 6 having an intended shape and being composed of the stacked body of the first layer 61 and the second layer 62 is obtained.

An example of the second compound as above cannot be particularly limited to as long as it is bindable with the polymerization initiation site. However, it is preferable to include at least one of styrene, a (meta) acrylic acid ester-based compound, an epoxy-based compound, and an oxetane-based compound as its major constituent. These compounds are particularly easy to bind with the polymerization initiation site. Therefore, the polymerization initiation site and the second compound are bound to each other in a shorter time, thereby simplifying a step to form the second layer 62.

Further, these compounds are particularly superior in an insulation property. Therefore, the second layer 62 composed of the second compound, that is, the gate insulating layer 6, functions as an outstanding insulating layer.

Among them, examples of the (meth)acrylic acid ester-based compound include an aromatic (meth)acrylic acid ester-based compound such as a bisphenol A (meth)acrylic acid ester-based compound, a bisphenol F (meth)acrylic acid ester-based compound, a phenol novolac (meth)acrylic acid ester-based compound, a cresol novolac (meth)acrylic acid ester-based compound, a triphenolmethane (meth)acrylic acid ester-based compound, a bisphenol S (meth)acrylic acid ester-based compound, and a bisphenol (meth)acrylic acid ester-based compound; and an aliphatic (meth)acrylic acid ester-based compound such as an ethylene glycol di(meth)acrylic acid ester-based compound, a propyleneglycol di(meth)acrylic acid ester-based compound, a neopentyl glycol di(meth)acrylic acid ester-based compound, a trimethylolpropane tri(meth)acrylic acid ester-based compound, and a glycerine (meth)acrylic acid ester-based compound.

Further, examples of the epoxy-based compound include an aromatic epoxide-based compound such as a bisphenol A epoxide, a bisphenol F epoxide, a phenol novolac epoxide, a cresol novolac epoxide, trisphenolmethane epoxide, a bisphenol S epoxide, and a bisphenol epoxide; a glycidylether-based compound such as ethylene glycol diglycidylether, propyleneglycol diglycidylether, neopentyl glycol diglycidylether, trimethylolpropane triglycidylether, and glycerine diglycidylether; bis (2,3-epoxycyclopentyl)ether; his (2,3-epoxycyclohexylmethyl)adipate; bis (2,3-epoxy-6-methylcyclohexylmethyl)adipate; 3,4-epoxycyclohexylmethyl; 3,4-epoxycyclohexanecarboxylate; 3,4-epoxy-6-methylcyclohexylmethyl; 3,4-epoxy-6-methylcyclohexanecarboxylate; dicyclopentadieneoxide; vinylcyclohexeneoxide and the like.

Furthermore, the examples of the epoxy-based compound include compounds (cycloaliphatic epoxy-based compounds) shown by formulae 4 through 9.

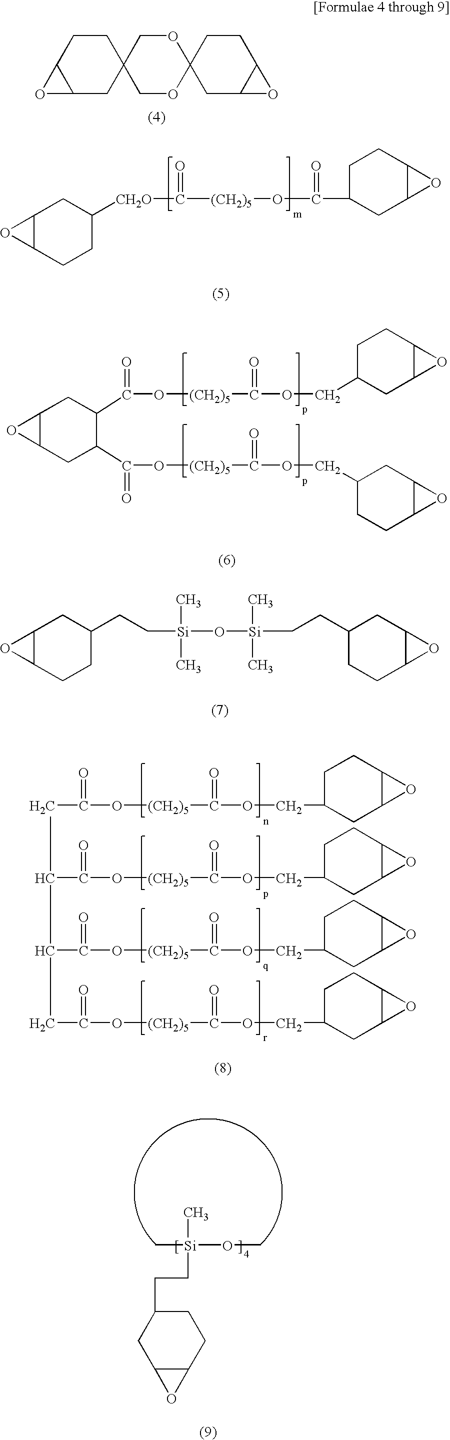

[Each of m in the formula 5, p in the formula 6, and n, p, q, r in the formula 8 indicates an integer that is one or more.]

In addition, examples of the oxetane-based compound include compounds shown by formulae 10 and 11.

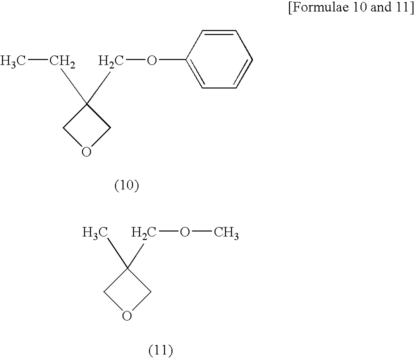

Average thickness of the gate insulation layer 6 is not particularly limited to, however, it is preferably from about 10 nm to about 5000 nm, and more preferably from about 50 nm to about 1000 nm. The gate insulation layer 6 having the thickness within the above ranges can ensure insulation of the gate electrode 7 from the source electrode 3 and the drain electrode 4, and lower the operating voltage of the thin-film transistor 1.

Further, the gate electrode 7 is provided on the gate insulating layer 6.

As a material of the gate electrode 7, the same materials that have been cited as ones for the source and drain electrodes 3 and 4 may be used.

Average thickness of the gate electrode layer 7 is not particularly limited to, however, it is preferably from about 0.1 nm to about 5000 nm, more preferably from about 1 nm to about 5000 nm, and further preferably from about 10 nm to about 5000 nm.

Further, the protective film 8 is provided on the gate insulating layer 6 so as to cover almost all of a surface thereof.

The protective film 8 mechanically protects each of the thin film transistors 1. In addition, when the active matrix device 30 is used for an electrophoretic display 20 to be described later, and an electrophoretic dispersion liquid 420 (lipophilic liquid) encapsulated in a micro capsule 42 flows outside somehow, the protective film 8 has a function to prevent the electrophoretic dispersion liquid 420 from diffusing towards the thin film transistor 1.

As a material composing the protective film 8 as above, for example, an organic material such as polyvinyl alcohol, ethylene-vinyl alcohol copolymer, vinyl chloride-vinyl alcohol copolymer or vinyl acetate-vinyl alcohol copolymer, or an inorganic material such as SiO₂ can be used.

Average thickness of the protective film 8 is not particularly limited to, however, it is preferably from about 100 nm to about 5000 nm, and more preferably from about 300 nm to about 3000 nm. Accordingly, the protective film 8 can sufficiently provide its performance.

In the thin film transistor 1 as above, the amount of a current flowing between the source and drain electrodes 3 and 4 is controlled by changing a voltage applied to the gate electrode 7.

Namely, in an OFF state in which no voltage is applied to the gate electrode 7, even if some voltage is applied between the source electrode 3 and the drain electrode 4, only very little current flows because very little carriers exist in the organic semiconductor layer 5. Meanwhile, in an ON state in which a voltage is applied to the gate electrode 7, movable charges (carriers) are induced in a portion of the organic semiconductor layer 5 that faces the gate insulating layer 6, and thus a path of carriers is formed in the channel region 51. When a voltage is applied between the source and drain electrodes 3 and 4 in this state, a current flows through the channel region 51.

[Method for Manufacturing Active Matrix Device]

Next, a method for manufacturing an active matrix device (an example of the method for manufacturing an electronic device according to the invention) shown in FIG. 1 will be described.

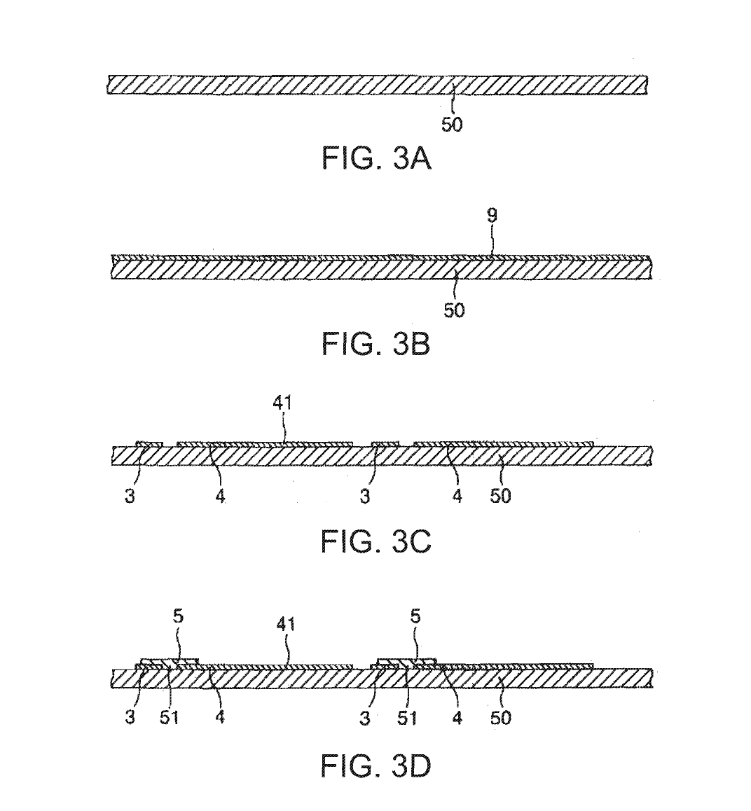

FIGS. 3A through 5J are diagrams (longitudinal sectional views) explaining the method for manufacturing the active matrix device shown in FIGS. 1 and 2. In the following description, the top side in FIGS. 3A through 5J is described as “up”, while the bottom side is described as “down” The method for manufacturing the active matrix device 30 includes: [1] forming electrodes (except for a gate electrode) and wiring; [2] forming an organic semiconductor layer; [3] forming a gate insulating layer; [4] forming the gate electrode; and [5] forming a protective film. Now, each step will be described below sequentially.

[1] Forming Electrodes and Wiring

As shown in FIG. 3A, the substrate 50 is prepared first, then the source electrode 3, the drain electrode 4, the pixel electrode 41, a data line (not shown), and a connection electrode (not shown) are formed on the substrate 50.

Then, as shown in FIG. 3B, a metal film 9 (metal layer) is formed on the substrate 50. This can be achieved by the following methods, for example: chemical vapor deposition (CVD) including plasma CVD, thermal CVD, and laser CVD; vacuum deposition; sputtering (low-temperature sputtering); dry plating such as ion plating; wet plating including electrolytic plating, immersion plating, and electroless plating; spraying; sol-gel processing; an MOD method; and metal foil bonding.

Then, on the metal film 9, a resist layer having a shape corresponding to shapes of the source electrode 3, the drain electrode 4, the pixel electrode 41, the data line, and the connection electrode is formed by photolithography. The resist layer is used as a mask to remove an unnecessary portion of the metal film 9.

This metal film 9 can be removed by one or more than one in combination of the following exemplary methods; physical etching such as plasma etching, reactive ion etching, beam etching, and photo assist etching; and chemical etching such as wet etching.

And then, by removing the resist layer, as shown in FIG. 3C, the source electrode 3, the drain electrode 4, the pixel electrode 41, the data line (not shown), and the connection electrode (not shown) can be obtained.

The source electrode 3, the drain electrode 4, the pixel electrode 41, the data line, and the connection electrode may also be formed by providing a liquid material such as a colloidal liquid (dispersion liquid) containing conductive particles, a liquid (solution or dispersion liquid) containing conductive polymer, or the like on the substrate 50 so as to form a coating film and followed by post treatment (for example, heating, infrared ray irradiation, and ultrasonic wave application) as necessary.

Examples of a method for providing the liquid material described above on the substrate 50 include a dipping method, a spin-coating method, a casting method, a micro gravure coating method, a gravure coating method, a bar coating method, a roller coating method, a wire bar coating method, a dip coating method, a spray coating method, a screen printing method, a flexographic printing method, an offset printing method, an ink jet method, and a micro-contact printing method. These methods can be used singly or in combination of two or more of them.

Among them, the inkjet method (droplet discharge method) is especially preferable to be employed. With the inkjet method (droplet discharge method), the source electrode 3, the drain electrode 4, the pixel electrode 41, the data line, and the connection electrode are formed with ease and high accuracy of dimension.

[2] Forming Organic Semiconductor Layer

Then, as shown in FIG. 3D, the organic semiconductor layer 5 is formed on the substrate 50 having the source electrode 3 and the drain electrode 4 formed thereon so as to cover the region between the source electrode 3 and drain electrode 4, a part of the source electrode 3, and a part of the drain electrode 4.

In this case, the channel region 51 is formed between the source electrode 3 and the drain electrode 4 (a region corresponding to the gate electrode 7).

For example, when the organic semiconductor layer 5 is composed of an organic polymer material, the layer 5 is formed by providing the organic polymer material or a liquid material containing its precursor on the substrate 50 so as to cover the source and drain electrodes 3 and 4, and then necessary treatment (e.g. heating, irradiation of infrared rays, application of ultrasonic waves) is provided to this coating film.

As a method for providing the liquid material on the substrate 50, the methods described in step 1 may be used.

Note that the region in which the organic semiconductor layer 5 is formed is not limited to the structure shown in the drawings. Therefore the organic semiconductor layer 5 may be formed only in the region (the channel region 5) defined between the source electrode 3 and the drain electrode 4. According to this structure, in the case of arranging the plurality of thin film transistors 1 (elements) on a single substrate, leak currents and cross-talk between elements can be suppressed by forming the organic semiconductor layer 5 for each element independently of each other. In addition, this also reduces the amount of the organic semiconductor material to be used, and thereby cutting manufacturing cost.

[3] Forming Gate Insulating Layer

Next, the gate insulating layer 6 is formed on the organic semiconductor layer 5.

The method for manufacturing an electronic device according to the embodiment is used to form the gate insulating layer 6. Accordingly, the thin film transistor (an example of the electronic device according to the invention) 1 including the gate insulating layer (organic thin film) 6 with high density, being patterned in a predetermined shape at high accuracy of dimension, is effectively obtained.

Now, forming the gate insulating layer 6 will be described in detail.

[3-1] First, a liquid material containing the first compound is prepared. The first compound includes the polymerization initiation site that is bindable with the second compound and its structure is changed by responding to light.

As the first compound, the photocurable compound and the photodegradable compound are preferably used as described above. Between them, the photocurable compound is composed of a prepolymer material and a polymer material. These materials preferably include a structure of a repeated unit (hereinafter, also referred to as a first repeated structure unit) including the polymerization initiation site described above, and a structure of a repeated unit (hereinafter, also referred to as a second repeated structure unit) causing a cross-linking reaction by light irradiation. The first layer 61 composed of the photocurable compound having such a repeated structure unit ensures its strength attributable to the cross-linking reaction as described above. Further, the polymerization initiation site included therein ensures that the first layer 61 is bindable with the second compound.

When the photocurable compound is composed of those repeated structure units, density of a cross-linking structure formed by the cross-linking reaction of the photocurable compound and density of the polymerization initiation site included in the photocurable compound are adjustable by setting a ratio of each repeated structure unit. As a result, hardness (flexibility) and density of the first layer 61 obtained are adjustable.

Here, the polymerization initiation site included in the first compound is not particularly limited to, however, it can be a functional group that is bindable with the second compound. In particular among them, a functional group including halogen is preferable. Accordingly, in a step to be described later, for example, a double bond in the second compound is cleaved by an action of the polymerization initiation site, causing a continuous reaction to bond a connector generated by being cleaved to the polymerization initiation site. That is, excitation of such living polymerization is ensured.

An example of the photocurable compound as above is a compound in which each of the first repeated structure unit shown by the formula 1 below and the second repeated structure unit shown by the formula 2 below is included as a repeated structure unit.

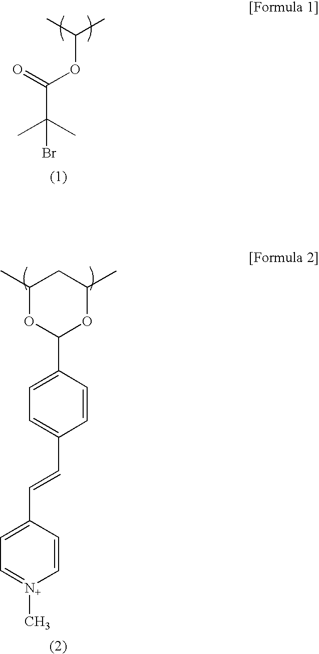

The photocurable compound including the first repeated structure unit shown by the formula 1 ensures excitation of the living polymerization. As a result, the polymerization initiation site and the second compound are bound to each other more effectively.

Further, the photocurable compound including the second repeated structure unit shown by the formula 2 can establish a more solid molecular network and provide the first layer 61 having more strength.

Furthermore, the photocurable compound preferably includes a third repeated structure unit with a hydrophilic site as shown by a formula 12.

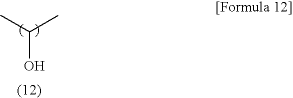

Accordingly, the photocurable compound is dissolved in a water-soluble solvent and handled at room temperature, facilitating preparation of the liquid material in this step, operation to provide the liquid material on the substrate, and cleaning operation of the coating film 60 to be described later. As a result, a simple operation and cost-reduction are expected in this step.

The photocurable compound as above can be synthesized by introducing each of the polymerization initiation site, the site causing a cross-linking reaction by light irradiation, and the hydrophilic site described above to a side chain of a straight-chain compound such as vinyl alcohol (PVA), for example.

The liquid material used in the step further includes a solvent that can dissolve the first compound.

The solvent can be a solvent that can dissolve the first compound and may be an inorganic or organic solvent or a mixed solvent including them. Examples of the inorganic solvent may include: nitric acid, sulfuric acid, ammonia, hydrogen peroxide, water, carbon disulfide, carbon tetrachloride, and ethylene carbonate. Examples of the organic solvent are various and may include: ketone solvents such as methyl ethyl ketone (MEK), acetone, diethyl ketone, methyl isobutyl ketone (MIBK) methyl isopropyl ketone (MIPK), and cyclohexanone; alcohol solvents such as methanol, ethanol, isopropanol, ethylene glycol, diethylene glycol (DEG), and glycerine; ether solvents such as diethyl ether, diisopropyl ether, 1,2-dimethoxyethane (DME), 1,4-dioxane, tetrahydrofuran (THF), tetrahydropyran (THP), anisole, diethylene glycol dimethyl ether (diglyme), and diethylene glycol ethyl ether (carbitol); cellosolve solvents such as methyl cellosolve, ethyl cellosolve, and phenyl cellosolve; aliphatic hydrocarbon solvents such as hexane, pentane, heptane, and cyclohexane; aromatic hydrocarbon solvents such as toluene, xylene, and benzene; heteroaromatic compound solvents such as pyridine, pyrazine, furan, pyrrole, thiophene, and methylpyrrolidone; amide solvents such as N,N-dimethylformamide (DMF), and N,N-dimethylacetamide (DMA); halogenated compound solvents such as dichloromethane, chloroform, and 1,2-dichloroethane; ester solvents such as ethyl acetate, methyl acetate, and ethyl formate; sulfur compound solvents such as dimethylsulfoxide (DMSO), and sulfolane; nitrite solvents such as acetonitrile, propionitrile, and acrylonitrile; and organic acid solvents such as formic acid, acetic acid, trichloroacetic acid, and trifluoroacetic acid.

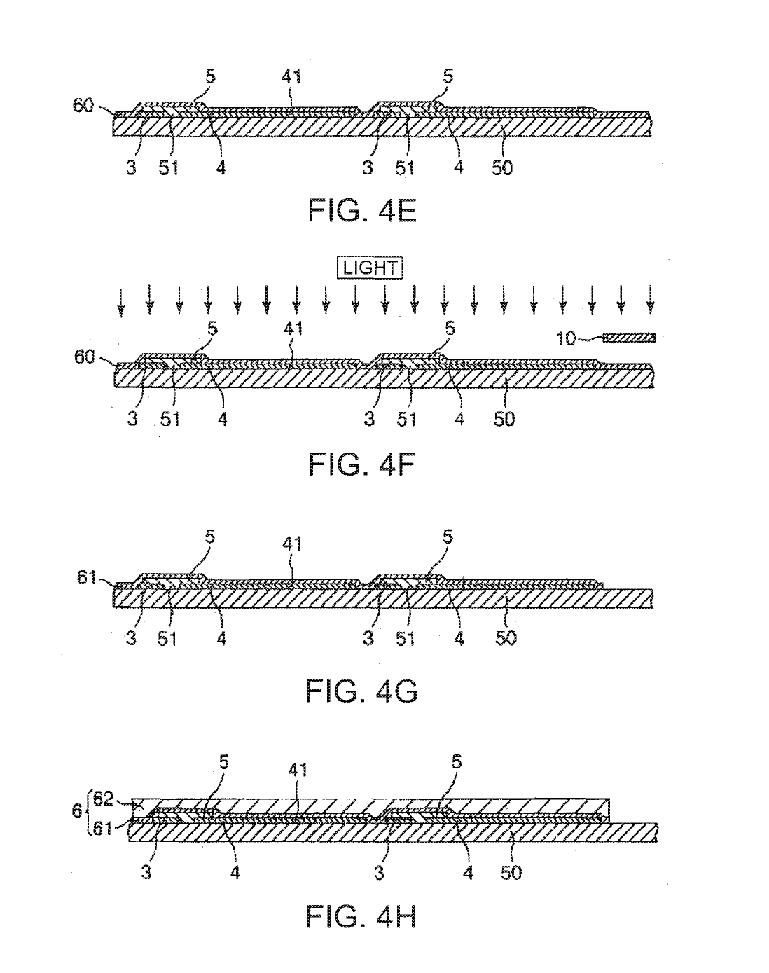

Next, the liquid material prepared is provided so as to cover the organic semiconductor layer 5 obtained in step 2 and the source electrode 3, the drain electrode 4, the pixel electrode 41, and the data lines 31 obtained in step 1, forming the coating film 60 shown in FIG. 4E (First step). The coating film 60 obtained as above has a shape of a liquid film.

[3-2] Next, as shown in FIG. 4F, light is irradiated to a predetermined region of the coating film 60 through a mask 10. Accordingly, the coating film 60 is patterned, providing the first layer 61 (Second step).

Now, the step is divided into a case 1 where the first compound is the photocurable compound and a case 2 where the first compound is the photodegradable compound to explain. Note that FIG. 4F shows the case 1 as an example.

Case 1

Here, the case using the photocurable compound shown by the formula 12 described above is explained as an example of the photocurable compound.

First, light is irradiated to the coating film 60 in a liquid film state through the mask 10. The mask 10 has an opening corresponding to a region where the gate insulating layer 6 should be formed. Accordingly, in the photocurable compound in the region where the light is irradiated, a double bond of the second repeated structure unit shown by the formula 2 is cleaved and bound to each other, causing a structure change such that a compound having a cross-linking structure is formed as shown in the formula 3. Due to the structure change, a solid molecular network by the second repeated structure unit is established. Therefore, the coating film 60 in the region where the light is irradiated is selectively solidified, forming the first layer 61.

On the other hand, light is not irradiated to a region on the coating film 60 other than the region where the gate insulating layer 6 should be formed. Therefore, the coating film 60 on the region does not have the structure change of the photocurable compound and remains in the liquid film state. As a result, the photocurable compound in the coating film 60 has difference in the structure thereof between the region with light irradiation and the region without light irradiation, that is, causing difference in presence of the molecular network. The difference appears as difference of resistance against a processing solvent in step 3-3 described later. Therefore, by making use of the difference, the coating film 60 is patterned, providing the first layer 61 shown in FIG. 4G.

Here, the photocurable compound preferably comes in contact with the polymerization initiator that accelerates the structure change with a cross-linking reaction described above. Accordingly, the cross-linking reaction of the photocurable compound is effectively performed, reducing time required for the step.

The polymerization initiator as above is preferably a radical-type photo-polymerization initiator that generates radical by light application and induces cleavage and bond (radical polymerization) of the double bond by the radical generated, for example. Accordingly, when the double bond is included in the second repeated structure unit, the radical-type photo-polymerization initiator can act and induce the radical polymerization particularly effectively.

Examples of the photo-polymerization initiator as above may include acetophenone, benzophenone, benzoyl ether, thioxanthone, camphorquinone, 2,4,6-trimethylbenzoyldiphenylphosphine oxide, ketals, dibenzoyls, onium salt and nuclear substitution derivatives thereof. These can be used singly or in combination of two or more of them.

Among these photo-polymerization initiators, examples that are preferably used are 2-hydroxy-2-methyl-1-phenylpropane-1-one, 1-hydroxycyclohexylphenylketone, 1-(4-isopropylphenyl)-2-hydroxy-2-methylpropane-1-one, benzyl dimethyl ketal, alpha,alpha-dimethoxy-alpha-morpholino-methylthiophenylacetophenone 2-methyl-4′-(methylthio)-2-morpholino-propiophenone, 2-benzyl-2-(dimethylamino)-4-morpholinobutylphenone, aromatic sulfonium salt, aromatic iodonium salt, and a mixture of 2,4-diethylxanthone and p-dimethylaminobenzoic acid methyl.

An amount of the polymerization initiator to be used is preferably from about 0.01 wt % to about 10 wt %, more preferably from about 0.1 wt % to about 5 wt %, further preferably from about 0.1 wt % to about 2 wt %, with respect to a weight of the coating film 60. This allows the polymerization initiator sufficiently to act on a site of the cross-linking reaction, and suppresses an excessive amount of the polymerization initiator.

Here, a light absorption coefficient of the second repeated structure unit with respect to a wavelength of light to be irradiated is preferably larger than that of the first repeated structure unit. Therefore, when light is irradiated, an amount of light energy absorbed by the first repeated structure unit is suppressed while the light energy is absorbed highly selectively by the second repeated structure unit. As a result, the cross-linking reaction forming the cross-linking structure of the second repeated structure unit is effectively performed while damage on the polymerization initiation site included in the first repeated structure unit is prevented.

In this case, the light absorption coefficient of the second repeated structure unit is preferably 100 times or more, more preferably 1000 times or more of that of the first repeated structure unit. Therefore, the first repeated structure unit is sufficiently prevented from absorbing light energy while the second repeated structure unit can absorb higher light energy.

Further, a ratio of the first repeated structure unit in the photocurable compound is preferably from 0.5 to 49.5 mol %, and more preferably from 5 mol % to 40 mol %. When the first repeated structure unit is included at such a ratio, the second compound can be bound to the polymerization initiation site at high density. That is, while the number of polymerization initiation sites that is sufficient for the second compound to bind at high density is ensured, molecules of the second compound are prevented from interfering each other because of the excessive number of polymerization initiation sites.

On the other hand, a ratio of the second repeated structure unit in the photocurable compound is preferably from 0.5 to 10 mol %, and more preferably from 2 mol % to 8 mol %. The second repeated structure unit included at such a ratio further ensures that a molecular network by the second repeated structure unit is formed. That is, it can surely prevent a case where a sufficient size of the molecular network is not formed due to lack of the second repeated structure unit, or a case where the molecular network is inhibited to form by the molecules of the second repeated structure unit interfering each other due to an excessive second repeated structure unit. The first layer 61 is thus solidified reliably.

Further, a ratio of the third repeated structure unit in the photocurable compound is preferably from 50 to 89.5 mol %, and more preferably from 52 mol % to 87 mol %. The third repeated structure unit included at such a ratio can sufficiently enhance hydrophilicity of the photocurable compound. As a result, the photocurable compound is ensured to dissolve in a water-soluble solvent, resulting in the liquid material that is easy to handle in step 3-1 above.

In addition, the coating film 60 may be cleaned with a cleaner or the like after the light irradiation to the coating film 60, if necessary. The coating film 60 in the region corresponding to a light-shielding part of the mask 10 is thus effectively removed, providing the first layer 61.

In this case, the cleaner is not limited to, but preferably contains water as a major constituent. The cross-linking structure obtained by the cross-linking reaction described above is hardly dissolved in water. Therefore, the coating film 60 after the light irradiation is cleaned with the cleaner containing water as the major constituent, ensuring removal of unnecessary part while the first layer 61 is retained.

Case 2

In this case, prior to light irradiation to the coating film 60, heat treatment (prebaking) is performed in a short time to the coating film 60 in a liquid film state. The coating film 60 is thus solidified. Next, light is irradiated on the coating film 60 other than the region where the gate insulating layer 6 should be formed. Accordingly, the photodegradable compound in the region where the light is irradiated is structurally changed to decompose.

On the other hand, light is not irradiated to the region where the gate insulating layer 6 should be formed. Therefore, the photodegradable compound on the region does not have the structure change by the light irradiation and the coating film 60 remains in a solidified state. Therefore, the photodegradable compound in the coating film 60 has difference in the structure thereof between the region with light irradiation and the region without light irradiation. The difference appears as difference of resistance against the processing solvent in step 3-3 described later. Therefore by making use of this difference, the coating film 60 is patterned, providing the first layer 61 shown in FIG. 4G.

In either the case 1 or the case 2, a wavelength of the light to be irradiated to the coating film 60 is preferably from about 200 to about 500 nm, more preferably from about 200 to about 400 nm, and further preferably from about 300 to from 350 nm. When the wavelength of the light as above is used, relatively high light energy is provided to the first repeated structure unit while damage on the polymerization initiation site included in the first repeated structure unit is prevented for certain. Accordingly, the structure change of the coating film 60 caused by the light irradiation is effectively performed.

[3-3] Next, the first layer 61 obtained in step 3-2 is contacted with a liquid containing the second compound. Accordingly, the polymerization initiation site in the first layer 61 and the second compound are bound to each other, providing the second layer 62 (Third step). Then, as shown in FIG. 4H, the gate insulating layer 6 patterned in an intended shape and composed of a stacked body of the first layer 61 and the second layer 62 is obtained.

Further, the liquid to be contacted with the first layer 61 preferably further includes a catalyst to accelerate binding of the polymerization initiation site and the second compound. Accordingly, the polymerization initiation site and the second compound are effectively bound to each other, reducing time required for the step.

Examples of the catalyst as above are metal catalysts including Cu, Fe, Au, Ag, Hg, Pd, Pt, Co, Mn, Ru, Mo, Nb, or the like. Typically, CuBr is used. They may be used singly or in combination.

Due to the contact of the first layer 61 with the second compound in the step, the second compound is bound to the molecule network in the first layer 61 as a pendant group. The first layer 61 is thus stacked, forming the second layer 62 composed of the second compound.

Further, the second compound bound to the first layer 61 by the graft polymerization is bound to another second compound, providing the second layer 62 that is thicker.

Here, the polymerization initiation site and the second compound are preferably bound to each other by living polymerization. With the living polymerization, when a number of the second compounds are bound to the polymerization initiation site, a polymerization initiation site is regenerated at an end of the second compounds having been bound, causing a continuous reaction in which the polymerization reaction occurs every time when the second compound is newly provided.

Accordingly, by changing a quantity of the second compound (monomer) to be provided to a reaction system, a degree of polymerization of the polymer to be synthesized becomes precisely controllable. As a result, thickness and density of the second layer 62 and the gate insulating layer 6 are adjustable adequately and precisely.

Further, the first layer 61 is preferably contacted with the liquid while light or heat is applied to the first layer 61. Activation of the polymerization initiation site is thus enhanced, resulting in further effective binding of the polymerization initiation site and the second compound. Consequently, as described above, when the first layer 61 includes the polymerization initiation site at high rate, a number of the second compounds can be bound to the polymerization initiation site. Therefore, density of the second layer 62 is increased, effectively providing the gate insulating layer 6 that is superior in electrical characteristics, mechanical characteristics, and chemical characteristics.

In this case, it is preferable to apply light or heat with an amount of energy that does not damage the polymerization initiation site.

Meanwhile, an organic thin film in related art is also formed by graft polymerization in which the second compound is bound to the polymerization initiation site in the first compound. In the above-mentioned related art method, a heat-curable compound in which a cross-linking reaction is caused by heat is used as the first compound.

Here, when a coating film having a fine pattern is formed by the related art method as above, heat needs to be applied on a substrate along the desired pattern after a liquid material including the heat-curable compound is provided on a whole of the substrate. However, since it is extremely hard to partially heat the substrate, an organic thin film in a fine pattern cannot be provided high accuracy of dimension.

Further, even if the heat-curable compound includes a polymerization initiation site, the polymerization initiation site is damaged by heat when the substrate is heated, resulting in a problem in which an effective polymerization initiation site is decreased. Therefore, the second compound is not polymerized at high density by the graft polymerization.

On the other hand, a method such as an ink-jet method providing a liquid material along a desired pattern has also been tried. However, in this method, the liquid material is not provided at a sufficient speed, resulting in extremely low efficiency in forming an organic thin film.

Therefore, in related art, it is hard to obtain an organic thin film patterned at high accuracy of dimension with high density by the graft polymerization.

Meanwhile, the method for manufacturing an electronic device according to the embodiment of the invention, as described above, includes the first step to form a coating film composed of the first compound including a polymerization initiation site bindable with the second compound and inducing a cross-linking reaction by reacting to light, the second step to form the first layer by patterning the coating film by irradiating light on a predetermined region of the coating film, and the third step to bind the polymerization initiation site and the second compound by contacting a liquid including the second compound with the first layer so as to form the second layer on the first layer, forming an organic thin film.

With the method as above, an region in which light is irradiated can be adequately arranged, forming the first layer 61 patterned at high accuracy of dimension. Accordingly, an organic thin film at high accuracy of dimension is effectively provided.

Further, a polymerization initiation site composed of a functional group or the like is commonly damaged by application of high energy. On the contrary, in the embodiment, the polymerization initiation site in the first compound is hard to be damaged. This is because, light can induce a structure change such as a cross-linking reaction of the first compound more effectively than heat, thereby reducing energy to be applied on the polymerization initiation site. Accordingly, the second compound is polymerized at high density by graft polymerization, effectively providing a coating film with high density.

[4] Forming Scanning Line (Gate Electrode)

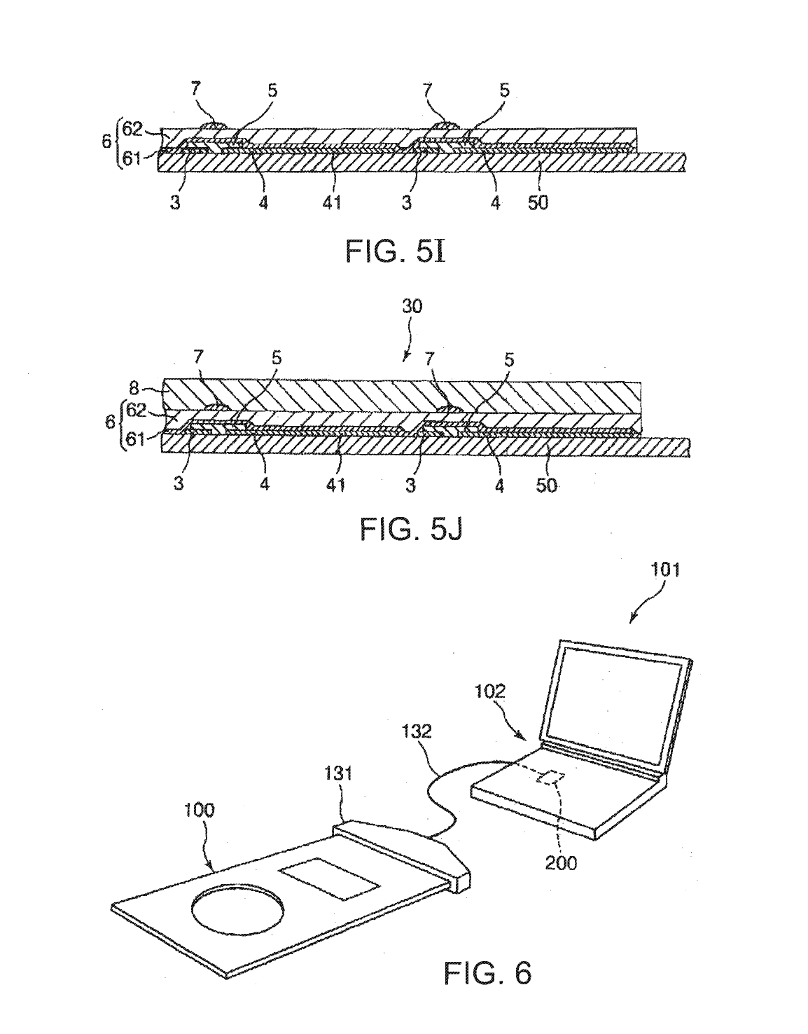

Next, as shown in FIG. 5I, the scanning line 32 (the gate electrode 7) is formed on the gate insulating layer 6.

The scanning line 32 can be formed in the same manner as the source electrode 3 and the drain electrode 4.

That is, the liquid material mentioned above is almost linearly provided so as to form a coating film as if to form the gate electrode 7 arranged in a line on the thin film transistor 1. Then by performing post treatment (e.g. heating, irradiation of infrared rays, application of ultrasonic waves) on the coating film according to need, forming the scanning line 32.

As a method to provide the liquid material, the inkjet method is preferable. The inkjet method enables the liquid material to be provided accurately corresponding to the scanning line 32. The scanning line 32 is thus formed with high accuracy of dimension.

[5] Forming Protective Film

Next, as shown in FIG. 5J, the protective film 8 is formed to cover almost all of a surface of the gate insulating layer 6.

The protective film 8 can be formed in the same manner as the gate insulating layer 6, for example.

Through the steps described above, the active matrix device 30 shown in FIGS. 1 and 2 can be obtained.

### Second Embodiment of an Electronic Device

Next, a biosensor including an electronic device according to a second embodiment of the invention will be explained.

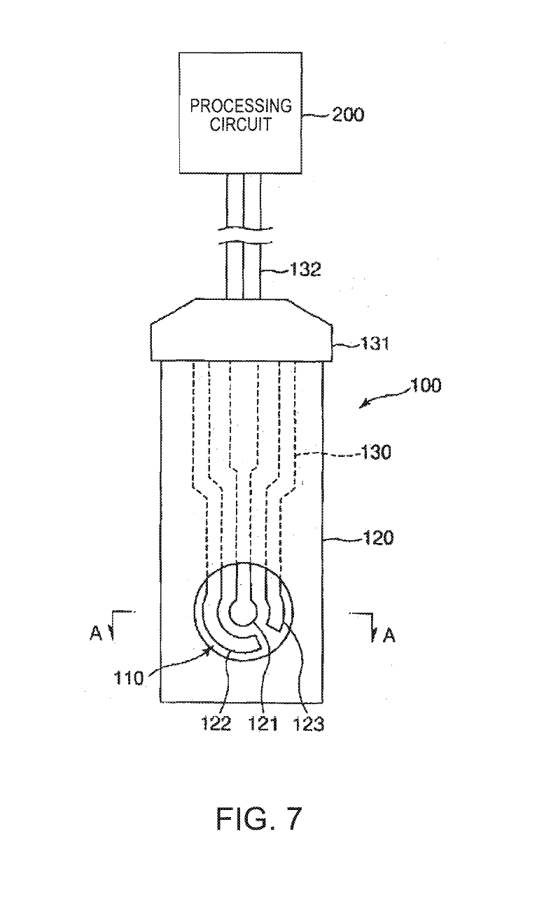

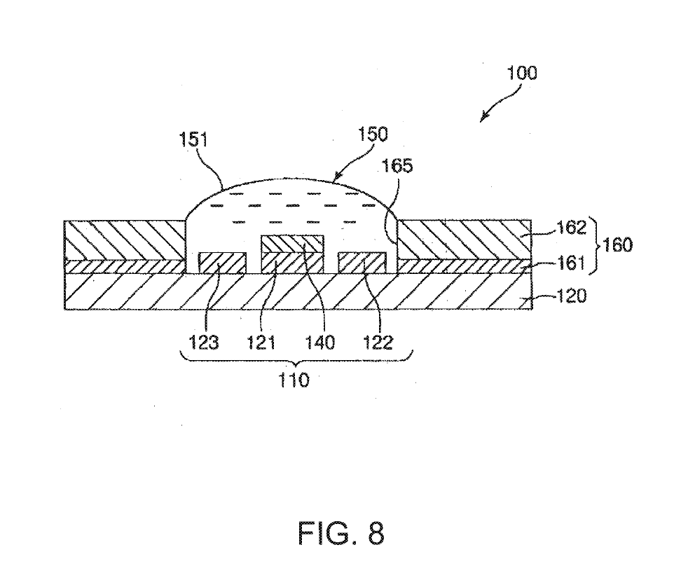

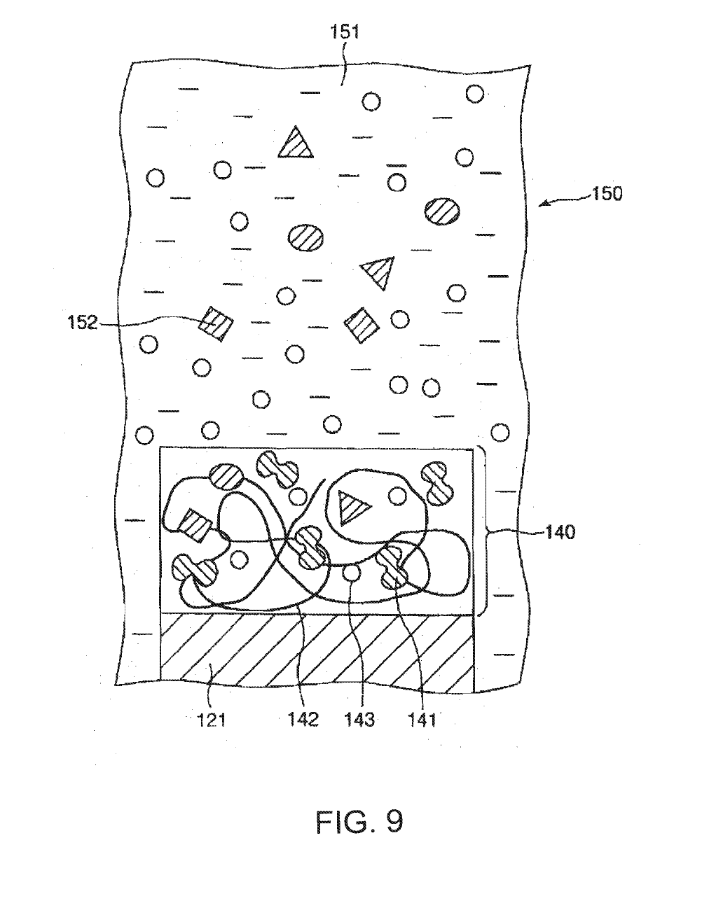

FIG. 6 is a schematic view (perspective view) showing a state in which the biosensor including the electronic device according to the second embodiment of the invention is attached to measuring equipment. FIG. 7 is a plan view schematically showing the biosensor shown in FIG. 6, while FIG. 8 is a sectional view of the biosensor shown in FIG. 7 cut along the line A-A. FIG. 9 is a partially enlarged view cut along the line A-A shown in FIG. 8. In the following description, the front side in FIG. 7 is described as “up”, while the back side is described as “down”. Further, the upper side of the FIGS. 8 and 9 is described as “top” and the lower side of the drawing is described as “bottom”.

The electronic device of the second embodiment (biosensor) and the method manufacturing it are described below. Each description is focused mainly on differences from the electronic device of the first embodiment (active matrix device) and the method for manufacturing it mentioned above, and the descriptions regarding the common matters are omitted.

The measuring equipment (an example of the electronic device of the invention) 101 shown FIG. 6 includes a biosensor 100, an arithmetic unit 102 provided with a processing circuit 200 analyzing a current value obtained with the biosensor 100, a connector 131 for mounting the biosensor 100, and a wiring 132 to connect the processing circuit 200 to the connector 131.

The biosensor 100 includes a detection portion 110 provided with a working electrode 121, a counter electrode 122, and a reference electrode 123 on a substrate 120.

These electrodes 121, 122, and 123 are independently and electrically coupled to the processing circuit 200 through a wiring 130, the connector 131, and the wiring 132. Further, the biosensor 100 is detachable from the connector 131.

Furthermore, the surface of the substrate 120 other than the detection portion 110 is covered with an insulating film 160 as shown in FIG. 8. That is, the insulating film 160 is formed on the substrate 120 and the detection portion 110 is exposed at an opening 165 formed at a part of the insulating film 160.

The biosensor 100 as above, as shown in FIG. 8, a liquid sample 151 is provided in a sample providing space 150 formed by the substrate 120 and the insulating film 160, thereby contacting the liquid sample 151 with a reaction layer 140 formed on the working electrode 121 to be described later. Then, a target in the liquid sample 151 reacts with the reaction layer 140, thereby an electric current is taken out from the working electrode 121. Accordingly, an amount of the target in the liquid sample 151 is measured based on a change of the electric current.

Examples of the liquid sample 151 include body fluids such as blood, urine, sweat, lymph, liquor cerebrospinalis, bile, and saliva, and processed liquids that these body fluids are subjected to various processes.

Further, the target included in the liquid sample 151 emits electrons (e−) by reacting with a receptor, which will be described later.

Examples of the target include sugars such as glucose, proteins such as simple protein and glycoprotein, alcohols, steroids such as cholesterol, steroid hormones, bile acid, and bile alcohol, vitamins, hormones, lactic acid, bilirubin, uric acid, and creatinine.

The substrate 120 supports each of portions composing the biosensor 100 while insulating the electrodes 121, 122, 123, and wiring 130 described above from each other.

As a constituent material of the substrate 120, one or more than one in mixture of the following exemplary materials can be used: resin materials such as polyethylene, polypropylene, polystyrene, polyethylene terephthalate (PET), polyethylene naphthalate (PEN), polyimide (PI); glass materials such as quartz glass; and ceramics materials such as alumina, and zirconia.

Examples of the constituent material of the working electrode 121 include metal materials such as gold, silver, copper, platinum, and alloys thereof; metal oxide-based materials such as ITO; and carbon-based materials such as graphite.

On the upper side of the working electrode 121, the reaction layer 140 is provided.

As shown in FIG. 8, a part of the reaction layer 140 is exposed to the sample providing space 150. By supplying the liquid sample 151 to the sample providing space 150, the liquid sample 151 can come in contact with the reaction layer 140.

The reaction layer 140 includes a receptor 141 as shown in FIG. 9. Here, when the receptor 141 includes enzyme, the receptor 141 emits electrons by reacting (oxidation reaction) with a target 152 in the liquid sample 151 as described above.

Examples of the receptor 141 as above include polypeptide and oligopeptide like enzymes or antibodies, nucleic acids like DNA or oligonucleotide.

When the receptor 141 includes an antibody, the receptor 141 adsorbs an antigen that is a target. Further, the receptor 141 uniquely identifies the antigen and absorbs a secondary antibody including a marker activating enzyme or the like to generate electrons, emitting electrons similarly to the case of the enzyme described above.

Among them, each receptor 141 preferably includes enzyme. The enzyme is highly capable of identifying the target 152, realizing the biosensor 100 with high detection sensitivity. Further, a biosensor having enzyme as a receptor is easy and simple to handle.

As the enzyme, various oxidoreductases can be used depending on a type of the target 152 to be measured. For example, oxidases such as glucose oxidase (GOx), ascorbate oxidase (ASOx), lactate oxidase (LOx), uricase (uric acid oxidase) (UOx), galactose oxidase, pyruvate oxidase, D- or L-amino acid oxidase, amine oxidase, cholesterol oxidase, choline oxidase, glycerol oxidase, xanthine oxidase, glutamate oxidase, and horseradish peroxidase; and dehydrogenases such as alcohol dehydrogenase, glutamic acid dehydrogenase, cholesterol dehydrogenase, aldehyde dehydrogenase, glucose dehydrogenase, fructose dehydrogenase, sorbitol dehydrogenase, and glycerol dehydrogenase can be used.

In the embodiment, each reaction layer 140 is made by including (impregnating) the receptor 141 in a matrix (base) composed of a polymer 142 as shown in FIG. 9. Accordingly, the receptor 141 is prevented from diffusing in other layers and the liquid sample 151, ensuring occurrence of a reaction between the target 152 and the receptor 141 in the reaction layer 140.

The material of the polymer 142 composing the matrix is not limited to, however, one or more than one in mixture of the following exemplary materials can be used: natural polymers (natural resins) such as biologically-relevant polymers (animal-derived polymers) and plant-derived polymers; synthetic polymers (synthetic resins); and modified thereof. Among them, one mainly containing a biologically-derived polymer or modified thereof is preferable for the polymer 142 composing the matrix. By using these materials, the receptor 141 is favorably prevented from being modified or deactivated easily.

Examples of the biologically-relevant polymers as above include sugars, protein substances (especially albumin (e.g. bovine serum albumin: BSA), globulin, and myoglobin), and nucleic acid (DNA, RNA).

Further, examples of the modified substances are substances treated so as to disrupt hydrophobic bonding, hydrogen bonding, and ion bond of the biologically-relevant polymers. Examples of the treatment are heat treatment, pressure treatment, pH controlling, treatment using a denaturant.

Further, the matrix preferably has a cross-linking structure formed. Accordingly, the receptor 141 is tightly held (carried) within the matrix. In addition, it contributes to improve mechanical strength of the reaction layer 140.

When a cross-linking agent that mainly includes peptide as a polymer is used to form the cross-linking structure on the matrix, one or more than one in mixture of the following exemplary materials can be used: glutaraldehyde, 1-ethyl-3-(3-dimethylaminopropyl)carbodiimide, trinitromethane, aqueous titanium oxide (titanium lactate [(OH)₂Ti(C₃H₅O₂)₂]), titanium triethanolaminate [(C₃H₇O)₂Ti(C₆H₁₄O₃N)₂]), aqueous zirconium oxide (zirconyl acetate [ZrO(OCOCH₃)₂]).

Further, the reaction layer 140 preferably includes a mediator 143 that carries emitted electrons to an intermediate layer described later or the working electrode. The mediator 143 generally induces an oxidation reaction at a lower electric potential compared to the target 152. Therefore, the mediator 143 adopted as intermediary of electron transfer enables electrons to transfer efficiently from the reaction layer 140, thereby an electric current is taken out from the detection portion 110 with higher sensitivity.

As the mediator 143, one or more than one in mixture of the following exemplary substances can be used: potassium ferricyanide; ferrocene and its derivatives; nickelocene and its derivatives; pyridine and its derivatives, quinone and its derivatives such as p-benzoquinone, and pyrrolo quinoline quinone; flavin derivatives such as flavin adenine dinucleotide (FAD); nicotinamide derivatives such as nicotinamide adenine dinucleotide (NAD) and nicotinamide adenine dinucleotide phosphate (NADP); phenazine methosulfate; 2,6-dichlorophenol indophenol; hexacyanoferrate (III); and octacyanotungsten ion; porphyrin derivatives; phthalocyanine derivatives.

The counter electrode 122 is an electrode to apply a voltage between the counter electrode 122 and the working electrode 121. While the liquid sample 151 is supplied to the sample providing space 150, a voltage is applied between the working electrode 121 and the counter electrode 122 so that the side of the working electrode 121 has a high potential, ensuring transfer of electrons emitted due to the reaction between the target 152 and the receptor 141 toward the working electrode 121.

As constituent materials of the counter electrode 122, the materials same as those of the working electrode 121 described above are cited.

Further, an area of the counter electrode 122 is preferably twice or more, more preferably 10 times or more than that of the working electrode 121. This makes it possible to measure a value of the electric current more accurately.

The reference electrode 123 is an electrode to apply a voltage between the counter electrode 122 and the reference electrode 123. While the liquid sample 151 is supplied to the sample providing space 150, a voltage is applied between the reference electrode 123 and the counter electrode 122. Then the electric current between these electrodes is compared with the electric current between the working electrode 121 and the counter electrode 122, enabling measurement of the electric current generated by the reaction between the target 152 and the receptor 141 more accurately.

Examples of constituent materials of the reference electrode 123 may include silver-silver chloride, and mercury-mercury sulfate.

Further, the working electrode 121, the counter electrode 122, the reference electrode 123, and the wiring 130 are preferably composed of an aggregate of conductive material powder. Accordingly, these electrodes and the wiring are easily formed with various printing methods. As a result, a manufacturing step of the biosensor is considerably simplified, allowing cost-reduction of the biosensor.

As described above, the insulating film 160 includes the opening 165 in the vicinity of the detection portion 110. The opening 165 forms the sample providing space 150.

In the embodiment, the gate insulating film 160 is formed as a stacked body of a first layer 161 and a second layer 162. The first layer 161 is formed by patterning a coating film 160′ to be described later, being in a predetermined shape having the opening 165, while the second layer 162 is formed on the first layer 161 by graft polymerization.

Between them, the first layer 161 is composed of the first compound similarly to the first layer 61 in the first embodiment above.

Meanwhile, the second layer 162 is composed of the second compound similarly to the second layer 62 in the first embodiment above.

The insulating film 160 having such a structure has high density similarly to the gate insulating film in the first embodiment, thereby being particularly superior in electrical characteristics such as insulating property, mechanical characteristics, and chemical characteristics.

Average thickness of the insulating film 160 described as above is not limited to any specific value, but is preferably from about 10 to about 5000 nm, more preferably from about 50 to about 1000 nm. The insulating film 160 having the thickness in the range above ensures insulation among the electrodes 121, 122, 123 from each other and the wirings 130 from each other.

[Method for Manufacturing a Biosensor]

Next, the method for manufacturing the biosensor (an example of the method for manufacturing the electronic device according to the invention) shown in FIG. 8 will be described.

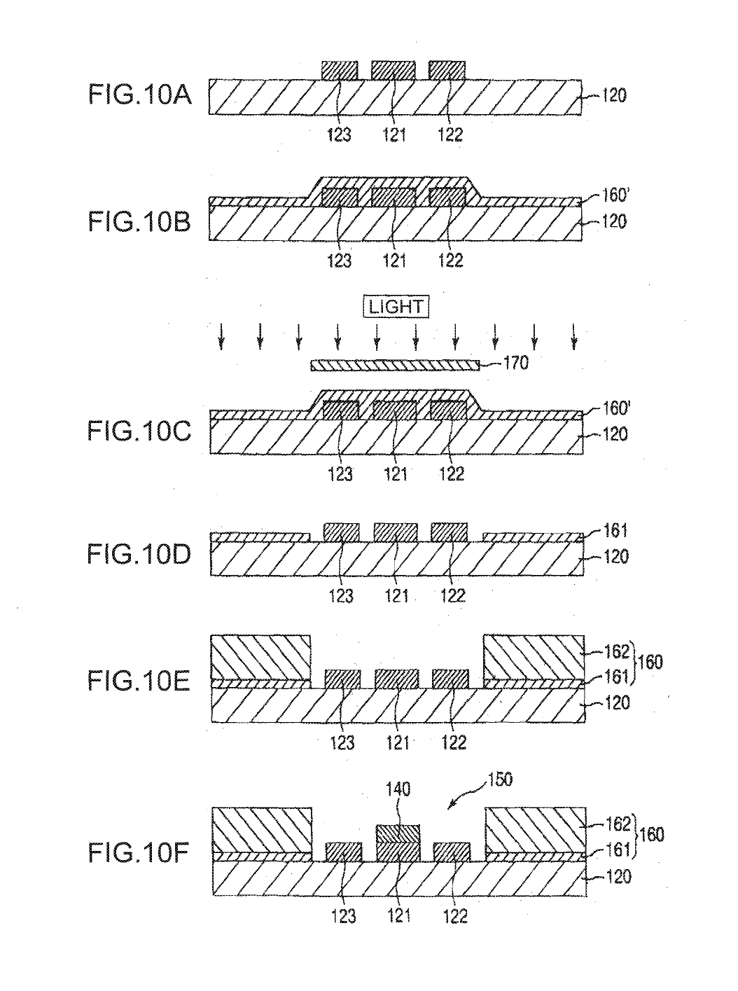

FIGS. 10A through 10F are diagrams (longitudinal sectional views) explaining the method for manufacturing the biosensor shown in FIG. 8. In the following description, the top side in FIGS. 10A through 10F is described as “up”, while the bottom side is described as “down”.

[1] First, the substrate 120 is prepared.

Then, the working electrode 121, the counter electrode 122, the reference electrode 123, and the wiring 130 are formed on the substrate 120 as shown in FIG. 10A. These electrodes and wiring can be formed in the same manner as the source electrode 3, the drain electrode 4, the pixel electrode 41, the data line 31, and the connection electrode 33 in the first embodiment.

[2] Next, the insulating film 160 having the opening 165 corresponding to a region of the detection portion 110 is formed.

The method for manufacturing the electronic device according to the embodiment is used to form the insulating film 160. Accordingly, the biosensor (an example of the electronic device according to the invention) 100 including the insulating film 160 with high density, being patterned in a predetermined shape at high accuracy of dimension, is effectively obtained.

Now, forming the insulating film 160 will be described in detail.

[2-1] First, a liquid material including the first compound is prepared similarly to the first embodiment. The liquid material is provided on the substrate 120 on which the electrodes 121, 122, 123, and the wiring 130 have been formed in the step above. The coating film 160′ shown in FIG. 10B is thus obtained (First step).

Here, an additive such as a binder may be added to the liquid material prepared in this step other than the first compound described above, if required.

Such an additive is included in a liquid material containing a heat-curable compound used in related art. However, the amount included is extremely small compared to that of related art. This is because reaction efficiency of the cross-linking reaction and density after the cross-reaction of the photocurable compound are higher than those of the heat-curable compound. Various additives to activate the reactions are thus omitted without any problems.

Therefore, the insulating film 160 formed by using the liquid material including the photocurable compound hardly includes the various additives described above. Commonly, it is known that the additives such as a binder cause an adversely affect such as decrease in activity on a biomaterial (e.g. a substance such as the target described above). Therefore, the insulating film 160 hardly including the additives can ensure that alteration or the like on the biomaterial is prevented from occurring in a case of a contact with the liquid sample 151 including the biomaterial.

[2-2] Next, similarly to the first embodiment described above, the coating film 160′ is irradiated by light through a mask 170 having an opening corresponding to a region on which the detection portion 110 should be formed as shown in FIG. 10C. The coating film 160′ is thus patterned, providing the first layer 161 (Second step) as shown in FIG. 10D.

In addition, the coating film 160′ may be cleaned with a cleaner or the like after the light irradiation on the coating film 160′, if necessary. The coating film 160′ in the region corresponding to a light-shielding part of the mask 170 is thus effectively removed, providing the first layer 161.

[2-3] Next, similarly to the first embodiment, the first layer 161 obtained in step 2-2 is contacted with a liquid containing the second compound. The second layer 162 as shown in FIG. 10E is thus obtained (Third step). Then, the insulating film 160 composed of the stacked body of the first layer 161 and the second layer 162 is obtained.

According to the method above, the insulating film 160 with high density and being patterned at high accuracy of dimension is effectively provided.

[3] Next, as shown in FIG. 10F, the reaction layer 140 is formed on the working electrode 121.

Now, a forming method is explained by exemplifying a case where each reaction layer 140 includes the receptor 141 in a matrix composed of the polymer 142 as shown in FIG. 9.

First, a liquid material is prepared by dissolving each of the receptor 141 and the polymer 142 into a solvent.

A cross-linking agent and the mediator 143 may be added into the liquid material, if necessary.

A concentration (an amount contained) of each component in the liquid material is set so that a rate of the content of the receptor 141 in the reaction layer 140 is in the range described above.

Subsequently, the liquid material is supplied into the sample providing space 150 in which the working electrode 121 is formed and left for one hour, followed by cleaning and drying. The reaction layer 140 is thus obtained.

According to the steps above, the biosensor 100 shown in FIG. 8 is obtained.

[Electronic Apparatus]

Next, various electronic apparatuses (examples of the electronic apparatus according to the invention) provided with the active matrix device 30 above will be explained.

[Electronic Paper]

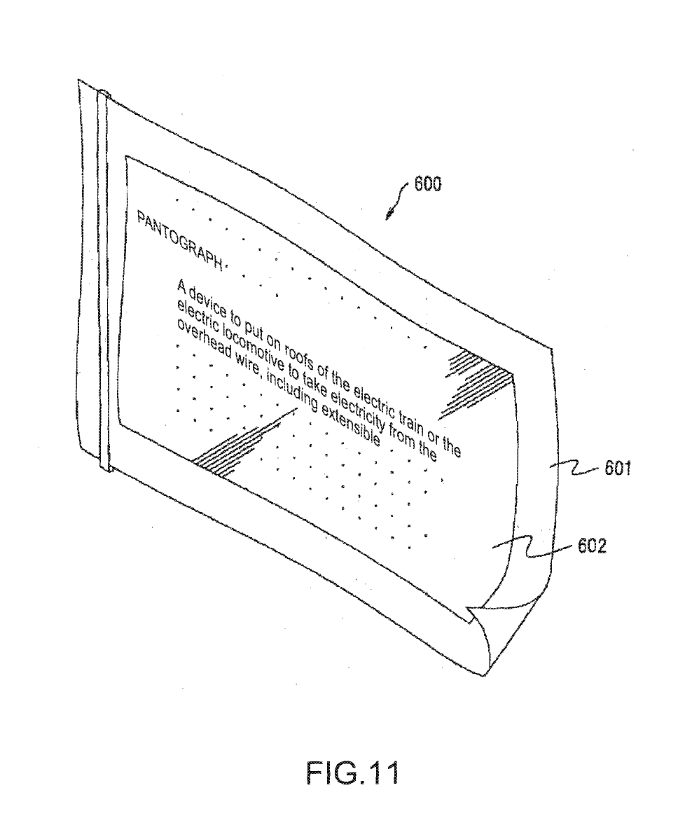

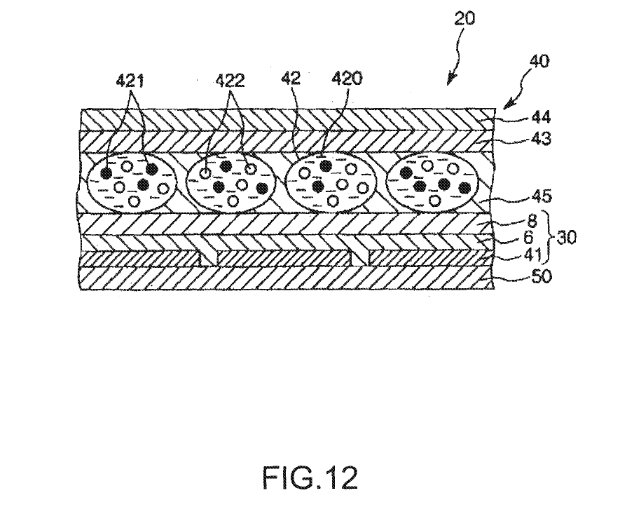

First, an electronic paper provided with the electronic apparatus of the invention will be described. FIG. 11 is a perspective view illustrating the electronic paper provided with the electronic apparatus according to the invention. FIG. 12 is a longitudinal sectional view showing an electrophoretic display provided with an active matrix device.

An electronic paper 600 shown in FIG. 11 includes a main body 601 that is composed of a rewritable sheet having the same texture and flexibility as those of papers, and a display unit 602.

In the electronic paper 600 as above, the display unit 602 is provided with the electrophoretic display 20 as shown in FIG. 12.

The electrophoretic display device 20 includes the active matrix device 30 formed on the substrate 50, and an electrophoretic display portion 40 electrically coupled to the active matrix device 30 as shown in FIG. 12.

In FIG. 12, the electrophoretic display portion 40 includes the pixel electrode 41, the micro capsule 42, a transparent electrode (a common electrode) 43 and a transparent substrate 44 which are sequentially deposited on the substrate 50.

The micro capsule 42 is fixed between the pixel electrode 41 and the transparent electrode 43 by a binder member 45.

The pixel electrode 41 is divided so as to be arrayed in a matrix, that is, orderly in rows and columns.

Each micro capsule 42 includes the electrophoretic dispersion liquid 420 that includes a plurality of electrophoretic particles having different characteristics. In here, two kinds of electrophoretic particles having different charges and colors (color phases), namely, electrophoretic particles 421 and 422, are encapsulated.

In the electrophoretic display 20 as above, when one or more of the scanning lines 32 are supplied with a selection signal (a selection voltage), the thin film transistor 1 coupled to the scanning line 32, which is shown in FIG. 1, supplied with the selection signal (selection voltage) is switched on.

The data line 31 coupled to the thin film transistor 1 is thus electrically conducted to the pixel electrode 41. Here, if desired data (voltage) are supplied to the data line 31, the data (voltage) are supplied to the pixel electrode 41.

Accordingly, an electric field is generated between the pixel electrode 41 and the transparent electrode 43, and the electrophoretic particles 421 and 422 are electrophoresed toward either of the electrodes in accordance with the direction and strength of the electric field, the characteristics of the electrophoretic particles 421 and 422, and so on.

On the other hand, if the supply of the selection signal selection voltage) to the scanning line 32 is stopped, the thin-film transistor 1 is switched off and the data line 31 and the pixel electrode 41 coupled to the thin film transistor 1 is disconnected.

Accordingly, by supplying or stopping the selection signal to the scanning line 32 and by supplying or stopping data to the data line 31 in appropriate combination, a desirable image (information) can be displayed on a display surface side (the transparent substrate 44 side) of the electrophoretic display 20.

In particular, in the electrophoretic display 20, the electrophoretic particles 421 and 422 are allowed to have different colors from each other, making it possible to display multiple grayscale images.

Further, the electrophoretic display 20 is provided with the active matrix device 30. Therefore, the thin film transistor 1 coupled to a specific scanning line 32 can selectively be switched ON/OFF and thus the problem of cross-talk hardly arises, and further, the circuit operation can be speeded up. Consequently, high quality images (information) can be produced.

Note that the electronic device according to the invention is not limited to the application to the electrophoretic display device 20 as described above, but can also be applied to liquid crystal display devices, organic or inorganic EL display devices and so on.

[Display]

Next, a display provided with the electronic apparatus according to the invention will be described.

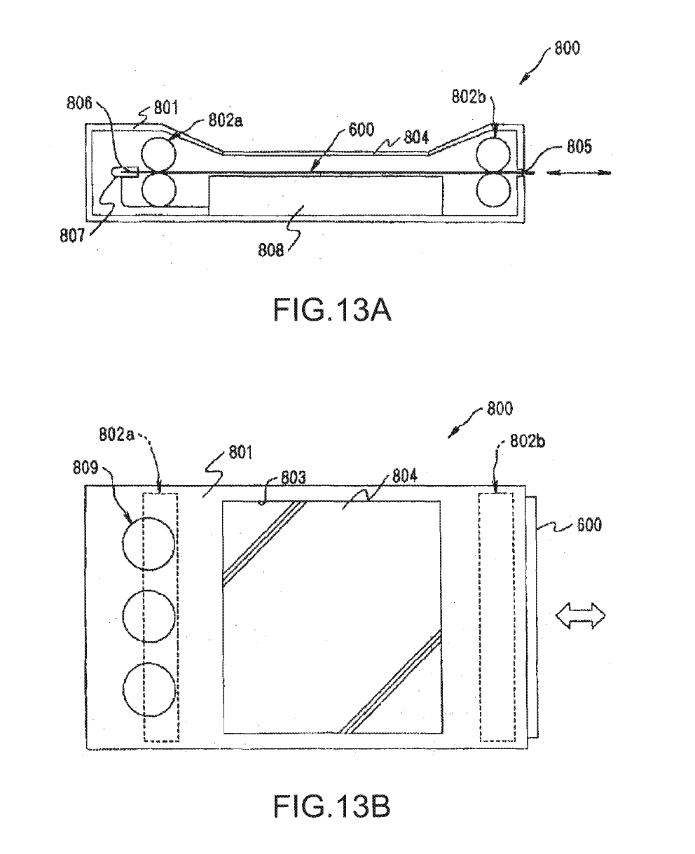

FIGS. 13A and 13B are diagrams showing the display provided with the electronic apparatus according to the invention. FIG. 13A is a sectional view, while FIG. 13B is a plan view.

A display 800 shown in FIGS. 13A and 13B includes a body 801 and the electronic paper 600 that is detachably provided to the body 801. The electronic paper 600 has the above-mentioned structure, that is, it is the same as the one shown in FIG. 11.

The body 801 has an insertion slot 805 on its side (right side in the figure) into which the electronic paper 600 is insertable. The body 801 also has a pair of feed rollers 802a and a pair of feed rollers 802b therein. When the electronic paper 600 is inserted through the insertion slot 805 into the body 801, the electronic paper 600 is fed to be set in the body 801 in a manner sandwiched by the pairs of feed rollers 802a and 802b.

The body 801 also has an opening 803 in a rectangular shape on the display side of the body 801 (front side in FIG. 13B). A transparent glass plate 804 is fitted in the opening 803. Accordingly, the electronic paper 600 set in the body 801 is visible from the outside of the body 801. In other words, the display 800 is provided with a display by making the electronic paper 600 set in the body 801 visible through the transparent glass plate 804.

Also, a terminal 806 is provided at an end in the direction toward which the electronic paper 600 is inserted (left side in the figure). Inside the body 801, a socket 807 coupled to the terminal 806 with the electronic paper 600 being set in the body 801 is provided. The socket 807 is electrically coupled to a controller 808 and a control part 809.

The electronic paper 600 is detachably set in the body 801 of the display 800, so that the electronic paper 600 can be also used out of the body 801 for portable use.

In the display 800, the electronic paper 600 includes the electrophoretic display 20 described above.

Note that the application of the electronic apparatus of the invention is not limited to those described above. Examples of the application include a television, a video tape recorder of a view-finder type or a monitor viewing type, a car navigation system, a pager, a personal digital assistance, an electronic calculator, an electronic newspaper, a word processor, a personal computer, a workstation, a picture phone, a POS terminal, and a device equipped with a touch panel. The electrophoretic display 20 can be applied to a display of the above various electronic apparatuses.

While the method for manufacturing an electronic device, the electronic device, and the electronic apparatus according to the invention have been described as above, they are not intended to limit the invention.

For example, the method for manufacturing an electronic device according to the invention can be employed in a case of manufacturing an electronic device provided with various organic thin films (an insulating film, a protective film and the like) requiring superior characteristics (electrical characteristics, mechanical characteristics, and chemical characteristics) due to high density, and high stability, other than the embodiments described above.

Further, for example, each of components of the electronic device and the electronic apparatus can be substituted by a given element that has a function of similar to the above-mentioned, and a given structure may be added to the above-mentioned.

In addition, in the method for manufacturing the electronic device, arbitrary steps can be also added as required.

The entire disclosure of Japanese Patent Application Nos: 2006-212619, filed Aug. 3, 2006 and 2007-166906, Jun. 25, 2007 are expressly incorporated by reference herein.

What is claimed is:

1. A method for manufacturing an electronic device including a substrate and an organic thin film patterned in a predetermined shape, comprising:
a) forming a coating film made of a first compound on a surface of the substrate, the first compound including a polymerization initiation site bindable with a second compound and inducing a cross-linking reaction responding to light;
b) forming a first layer by site-selective irradiation of light on a region corresponding to the organic thin film of the coating film so as to pattern the coating film in the predetermined shape; and
c) forming the organic thin film including the first layer and a second layer, the second layer being formed on the first layer by contacting a liquid including the second compound with the first layer so as to bind the polymerization initiation site and the second compound.

2. The method for manufacturing an electronic device according to claim 1, the first compound including a photocurable compound to be solidified by light irradiation as a major constituent.

3. The method for manufacturing an electronic device according to claim 2, the photocurable compound comprising at least one of a prepolymer material and a polymer material, the prepolymer material and the polymer material having a first repeated structure unit including the polymerization initiation site and a second repeated structure unit inducing a cross-linking reaction by light irradiation.

4. The method for manufacturing an electronic device according to claim 3, density of the polymerization initiation site being adjustable by changing a ratio of the first repeated structure unit included in the photocurable compound.

5. The method for manufacturing an electronic device according to claim 3, density of a cross-linking structure formed by the cross-linking reaction being adjustable by changing a ratio of the second repeated structure unit included in the photocurable compound.

6. The method for manufacturing an electronic device according to claim 3, the first repeated structure unit including a structure shown in a formula 1 below.

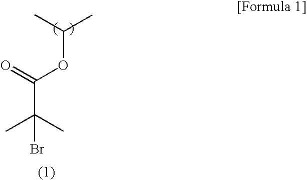

7. The method for manufacturing an electronic device according to claim 3, the second repeated structure unit including a structure shown in a formula 2 below.

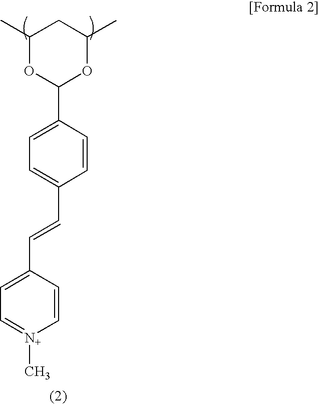

8. The method for manufacturing an electronic device according to claim 3, the ratio of the first repeated structure unit in the photocurable compound being from 0.5 mol % to 49.5 mol % inclusive.

9. The method for manufacturing an electronic device according to claim 3, the ratio of the second repeated structure unit in the photocurable compound being from 0.5 mol % to 10 mol % inclusive.

10. The method for manufacturing an electronic device according to claim 3, the photocurable compound further comprising a third repeated structure unit including a hydrophilic site.

11. The method for manufacturing an electronic device according to claim 1, step a) including contacting a polymerization initiator with the first compound, the polymerization initiator inducing the cross-linking reaction and generating radical by light irradiation.

12. A method for manufacturing an electronic device including a substrate and an organic thin film patterned in a predetermined shape, comprising:
d) forming a coating film made of a first compound on a surface of the substrate, the first compound including a polymerization initiation site bindable with a second compound and inducing a decomposition reaction responding to light;
e) forming a first layer by site-selective irradiation of light on a region other than a region corresponding to the organic thin film of the coating film so as to pattern the coating film in the predetermined shape; and
f) forming the organic thin film including the first layer and a second layer, the second layer being formed on the first layer by contacting a liquid including the second compound with the first layer so as to bind the polymerization initiation site and the second compound.

13. The method for manufacturing an electronic device according to claim 12, the first compound including a photodegradable compound to be decomposed by light irradiation as a major constituent.

14. The method for manufacturing an electronic device according to claim 1, the polymerization initiation site being a functional group including halogen.

15. The method for manufacturing an electronic device according to claim 1, the second compound including at one of a methacrylic acid ester-based compound, an acrylic acid ester-based compound, an epoxy-based compound, and an oxetane-based compound as a major constituent.

16. The method for manufacturing an electronic device according to claim 1, a wavelength of light to be irradiated in step b) being from 200 nm to 500 nm inclusive.

17. The method for manufacturing an electronic device according to claim 1, step c) including binding the polymerization initiation site to the second compound by living polymerization.

18. The method for manufacturing an electronic device according to claim 1, step c) including contacting the liquid with the first layer while at least one of light and heat is applied on the first layer.

19. An electronic device manufactured by the method for manufacturing an electronic device according to claim 1.

20. An electronic apparatus, comprising the electronic device according to claim 19.
